(19) United States
(12) Patent Application Publication
(10) Pub. No.: US 2011/0051617 A1
(43) Pub. Date: Mar. 3, 2011

(54) WIRELESS COMMUNICATION SYSTEM, TRANSMISSION APPARATUS AND COMMUNICATION CONTROL METHOD

(75) Inventor: Taku Nakayama, Yokohama-shi (JP)

(73) Assignee: Kyocera Corporation, Kyoto (JP)

(21) Appl. No.: 12/919,258

(22) PCT Filed: Feb. 25, 2009
(86) PCT No.: PCT/JP2009/053402

§ 371 Date: Aug. 25, 2010

(30) Foreign Application Priority Data
Feb. 27, 2008 (JP) 2008-046057

(51) Int. Cl. H04W 24/00; H04B 7/04

(52) U.S. Cl. 370/252; 370/328

(57) ABSTRACT

A transmission weight generation unit generates a plurality of transmission weights, while a communication quality obtain unit obtains a value indicating communication quality of each eigenpath. A transmission control unit, if reducing a size of a packet, controls to transmit the packet by dividing it into a plurality of eigenpaths and selects a transmission weight such that respective communication qualities of the eigenpaths become equivalent. The transmission control unit, if not reducing the size of the packet, controls to generate a plurality of packets and to transmit the packets by the eigenpaths and selects a transmission weight which maximizes overall communication quality of the plurality of eigenpath. A transmission weight policy determination unit obtains a type of the packet at transmission of the packet and determines whether to reduce the size of the packet.

### CROSS REFERENCE TO RELATED APPLICATION

This application claims priority to and the benefit of Japanese Patent Application No. 2008-46057 (filed on Feb. 27, 2008), the entire content of which is incorporated herein by reference.

### TECHNICAL FIELD

The present invention relates to wireless communication systems, transmission apparatuses and communication control methods for performing MIMO communication by using a plurality of antennas both at a transmission side and at a reception side.

### BACKGROUND ART

In recent years, MIMO (Multi-Input Multi-Output) transmission technology has been put into practical use. In the MIMO transmission system, both apparatuses at the transmission side and the reception side use a plurality of antennas, so as to improve a transmission speed and reliability. It is also known to further improve characteristics of MIMO by configuring the system such that the apparatus at the reception side feeds back channel information obtained to the apparatus at the transmission side and that the apparatus at the transmission side uses the information. This is referred to as closed loop MEMO or feedback MIMO.

Characteristics are improved as the information to be fed back is more detailed. This requires, however, a large amount of feedback information, which leads to tight system capacity.

In order to solve such a problem, it is possible to reduce the amount of feedback information dramatically by preparing a plurality of common transmission weights for both apparatuses at the transmission side and the reception side in advance and configuring the apparatus at the reception side to designate an index of transmission weight desired to be used at transmission.

At this time, the transmission weight is selected based on MIMO (SVD-MEMO) using singular value decomposition, and the apparatus at the reception side measures channel information and selects a transmission weight, which maximizes a sum of SINR (Signal to Noise plus Interference Ratio) of all eigenpaths when the channel information and the transmission weight are combined.

FIG. 6 is a flowchart illustrating a conventional method to select a transmission weight. According to the conventional method, candidates for the transmission weight are generated (step 301). Next, it is determined whether calculation of SINR of eigenpaths for all of the candidates for the transmission weight is finished (step 302). If the calculation is not finished (if No), SINR for each eigenpath is calculated for a current candidate for the transmission weight (step 303). Next, it is determined whether the sum of SINR of all eigenpaths exceeds a maximum value of the sum of SINR previously calculated (step 304). If exceeding (if Yes), the current candidate for the transmission weight and the sum of SINR are stored (step 305). If not exceeding (if No), it is once again determined whether the calculation of SINR of the eigenpaths for all of the candidates for the transmission weight is completed (step 302). If calculation for all of the candidates for the transmission weight is completed (if Yes), the candidate for the transmission weight stored is output (step 306).

### Patent Document 1: Japanese Unexamined Patent Application Publication No. 2005-522086

### DISCLOSURE OF THE INVENTION

### Problems to be Solved by the Invention

Although the characteristics of MIMO are improved by the conventional method to select a transmission weight, MIMO using the singular value decomposition generates significant difference in quality among eigenpaths. It is known, in such a case, to dramatically improve the overall characteristics by selecting a modulation scheme suitable for each eigenpath or performing a suitable correction processing. However, control for each path increases control information to an overall system capacity.

In addition, allocating an independent packet to each eigenpath requires more control information, which increases overhead of each packet. Especially, if a size of each packet is small such as VOIP (Voice Over IP) data, the overhead increasing rate is relatively high.

In order to avoid such a problem, there is a scheme, such as SCW (Single Code Word) which is one of an operation mode of MIMO, to modulate data in a single packet in a lump and divide a packet having a single control information into a plurality of eigenpaths.

However, the SCW scheme, same as the conventional method, increases difference in characteristics among eigenpaths if the transmission weight which maximizes a sum of SINR of all eigenpaths is selected. Therefore, it has a problem that if errors are occurred in some eigenpaths, the entire packet becomes error although there is no error in other eigenpaths.

In order to address such problems, an object of the present invention is to provide wireless communication systems, transmission apparatuses and communication control methods capable of taking advantages of MIMO fully, when employing the SCW scheme, by selecting a transmission weight such that respective qualities of the plurality of eigenpaths become equivalent as much as possible and the overall communication quality of the eigenpaths is increased.

### SUMMARY OF THE INVENTION

In order to achieve the above object, the present invention is characterized in a wireless communication system for performing wireless communication via a plurality of paths between a transmission apparatus and a reception apparatus, including: a communication quality obtain unit for obtaining information on communication quality of each of the paths; and a transmission control unit for controlling the transmission apparatus, when the transmission apparatus reduces packet size to transmit a packet, to transmit the packet by dividing it into the plurality of paths and for determining a transmission weight such that respective communication qualities of the paths become equivalent.

It is preferred that the transmission control unit determines a transmission weight which maximizes communication quality of a path with relatively low communication quality among the plurality of paths.

In addition, it is preferred that the wireless communication system according to the present invention further includes a transmission weight generation unit for generating a plurality of transmission weights, and wherein the transmission control unit selects a transmission weight among the transmission weights generated by the transmission weight generation unit, such that difference in values indicating communication qualities of the paths obtained by the communication quality obtain unit is equal to or lower than a predetermined value and a sum of all communication qualities of the plurality of paths is maximized.

It is preferred that the transmission apparatus reduces packet size when a packet to transmit is a voice packet, and that the transmission apparatus reduces packet size when a band to be used to transmit a packet is a narrowband.

In addition, it is preferred that the transmission control unit controls the transmission apparatus when the transmission apparatus does not reduce the packet size to transmit the packet, to generate a plurality of packets and to transmit the packets by respective paths, and determines a transmission weight which maximizes overall communication quality of the plurality of paths.

The present invention is characterized in a transmission apparatus for performing wireless communication via a plurality of paths, the transmission apparatus transmitting a packet by dividing it into the plurality of paths when reducing packet size to transmit the packet, and applying a transmission weight such that respective communication qualities of the paths become equivalent.

The present invention is characterized in a communication control method of a wireless communication system for performing wireless communication via a plurality of paths between a transmission apparatus and a reception apparatus, including the steps of: obtaining information on communication quality of each of the paths; and controlling the transmission apparatus, when the transmission apparatus reduces packet size to transmit a packet, to transmit the packet by dividing it into the plurality of paths, and determining a transmission weight such that respective communication qualities of the paths become equivalent.

### EFFECT OF THE INVENTION

According to the present invention, it is possible to take advantages of MIMO fully even when employing the SCW scheme, as the transmission apparatus selects a transmission weight such that respective qualities of a plurality of eigenpaths become equivalent as much as possible, and that the overall communication quality of eigenpaths can be maximized, when reducing overhead of a transmission packet in the closed loop MIMO communication.

### BRIEF DESCRIPTION OF DRAWINGS

FIG. 1 is a basic configuration diagram of a wireless communication system according to the present invention which transmits a single packet by a plurality of eigenpaths so as to reduce a size of a transmission packet;

FIG. 2 is a basic configuration diagram of the wireless communication system according to the present invention which generates a plurality of packets and transmits the packets by respective eigenpaths, without reducing the size of the packet;

FIG. 3 is a configuration diagram illustrating a transmission weight selection unit;

FIG. 4 is a flowchart illustrating a first embodiment to select the transmission weight;

FIG. 5 is a flowchart illustrating a second embodiment to select the transmission weight; and

FIG. 6 is flowchart illustrating a conventional operation to select the transmission weight.

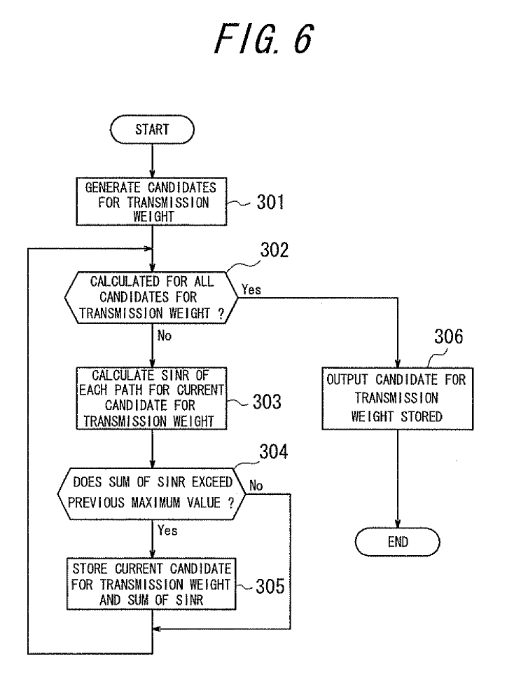

### DESCRIPTION OF EMBODIMENTS

Preferred embodiments of the present invention will be described with reference to the accompanying drawings.

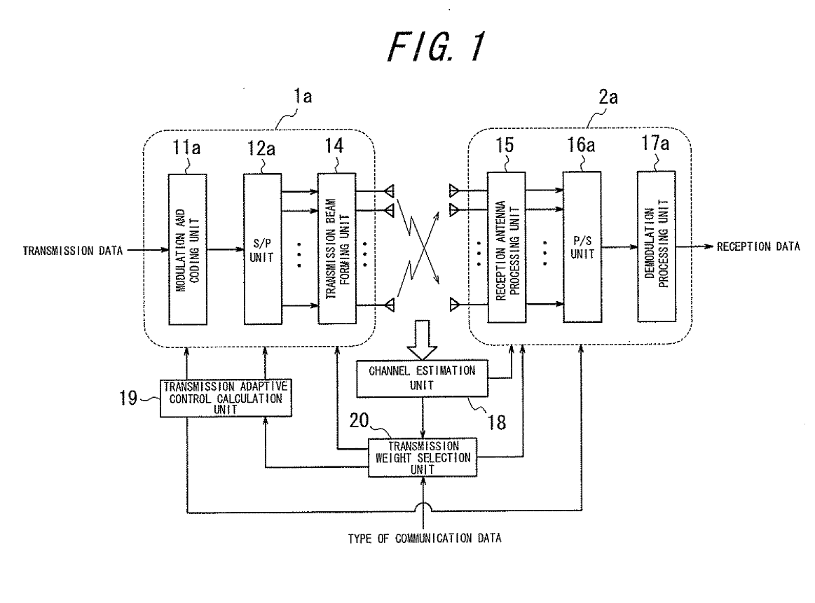

FIG. 1 is a basic configuration diagram of a wireless communication system according to the present invention which transmits a single packet over a plurality of eigenpaths by a MIMO scheme referred to as SCW, in order to reduce a size of a packet to transmit. As shown in FIG. 1, a transmission apparatus 1a has a plurality of transmission antennas and is provided with a modulation and coding unit 11a, an S/P unit 12a and a transmission beam forming unit 14. A reception unit 2a has a plurality of reception antennas and is provided with a reception antenna processing unit 15, a P/S unit 16a and a demodulation processing unit 17a. A channel estimation unit 18, a transmission adaptive control calculation unit 19 and a transmission weight selection unit 20 may be provided to either the transmission apparatus 1a or the reception apparatus 2a.

The modulation and coding unit 11a modulates and encodes transmission data based on information output by the transmission adaptive control calculation unit 19. The S/P unit 12a performs serial-to-parallel conversion on the transmission data output by the modulation and coding unit 11a and outputs the transmission data for each eigenpath. The transmission beam forming unit 14 forms a transmission eigenbeam by applying a transmission weight output by the transmission weight selection unit 20 to a transmission signal of each eigenpath output by the S/P unit 12a, and multiplexes the signal for each transmission antenna.

A MIMO channel is formed between the plurality of transmission antennas and the plurality of reception antennas. The reception antenna processing unit 15 performs spatial filtering by calculating a reception weight based on a result of channel estimation output from the channel estimation unit 18, or extracts a signal of each eigenpath by performing a maximum likelihood reception process. The P/S unit 16 performs the parallel-to-serial conversion on reception data of each eigenmode. The demodulation processing unit 17a performs error-correction demodulation and the likes and outputs the reception data.

Based on the signal received by the plurality of reception antennas, the channel estimation unit 18 estimates characteristics of the propagation path (channel estimation). The transmission adaptive control calculation unit 19 controls the modulation and coding unit 11a based on a value calculated by the transmission weight selection unit 20.

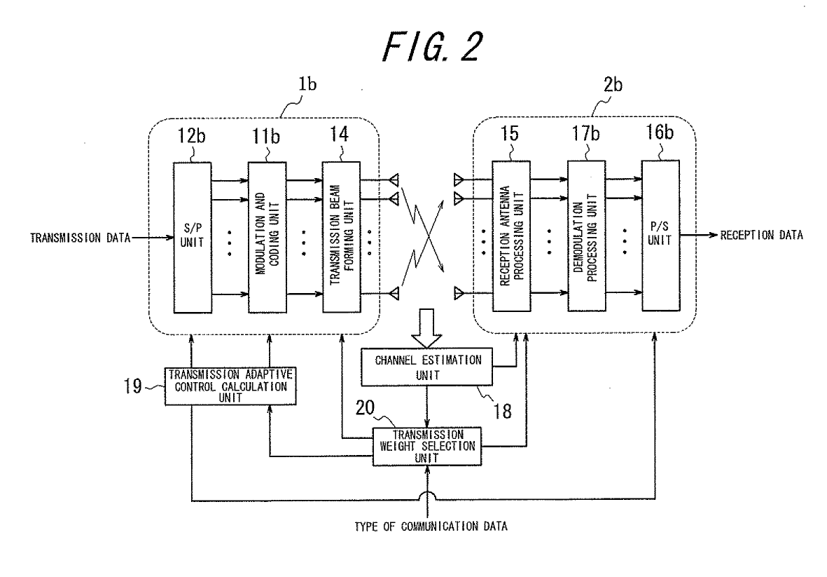

FIG. 2 is a basic configuration diagram of the wireless communication system according to the present invention which generates a plurality of packets and transmits the packets by the eigenpaths without reducing the size of the packet. As shown in FIG. 2, a transmission apparatus 1b has a plurality of transmission antennas and is provided with an S/P unit 12b, a modulation and coding unit 11b and a transmission beam forming unit 14. A reception unit 2b has a plurality of reception antennas and is provided with a reception antenna processing unit 15, a demodulation processing unit 17b and a P/S unit 16b. A channel estimation unit 18, a transmission adaptive control calculation unit 19 and a transmission weight selection unit 20 may be provided to either the transmission apparatus 1b or the reception apparatus 2b.

The S/P unit 12b performs serial-to-parallel conversion on the transmission data and outputs the transmission data for each eigenpath. The modulation and coding unit 11b modulates and encodes the transmission data for each eigenpath based on information output by the transmission adaptive control calculation unit 19. The transmission beam forming unit 14 forms a transmission eigenbeam by applying a transmission weight output by the transmission weight selection unit 20 to a transmission signal for each eigenpath output by the S/P unit 12b, and multiplexes the signal for each of the transmission antennas.

A MIMO channel is formed between the plurality of transmission antennas and the plurality of reception antennas. The reception antenna processing unit 15 performs spatial filtering by calculating a reception weight based on a result of channel estimation output from the channel estimation unit 18, or extracts a signal of each eigenpath by performing a maximum likelihood reception process. The demodulation processing unit 17b performs error-correction demodulation and the likes on the signal of each eigenpath based on information output by the transmission adaptive control calculation unit 19 and outputs the reception data. The P/S unit 16b performs the parallel-to-serial conversion on reception data of each eigenpath.

Based on the signal received by the plurality of reception antennas, the channel estimation unit 18 estimates characteristics of the propagation path (channel estimation). The transmission adaptive control calculation unit 19 controls the modulation and coding unit 11b based on a value calculated by the transmission weight selection unit 20.

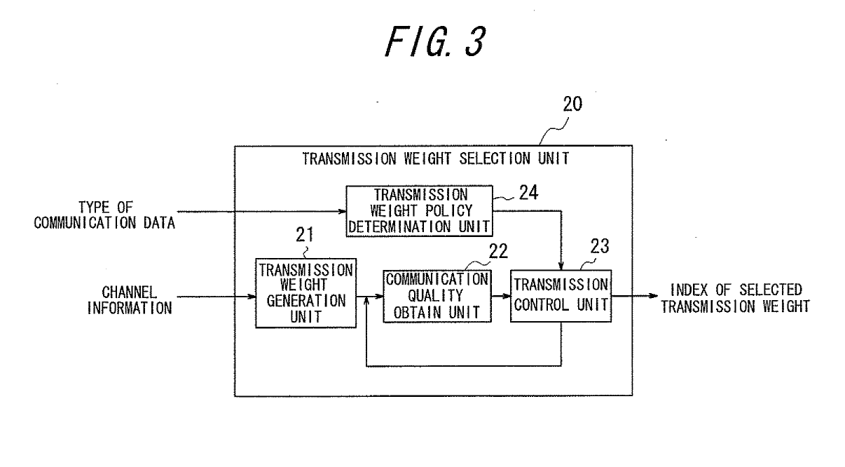

FIG. 3 is a configuration diagram of the transmission weight selection unit. The transmission weight selection unit 20 is provided with a transmission weight generation unit 21, a communication quality obtain unit 22, a transmission control unit 23 and a transmission weight policy determination unit (judging unit) 24. The transmission weight generation unit 21 generates a plurality of transmission weights. The communication quality obtain unit 22 obtains a value indicating communication quality of each eigenpath. The transmission control unit 23, in case of reducing a size of a packet, controls so as to transmit the packet by dividing it into the plurality of eigenpaths and determines (selects) a transmission weight such that the respective communication qualities of the eigenpaths become equivalent. Specifically, the transmission control unit 23 determines (selects) a transmission weight which maximizes communication quality of an eigenpath with relatively low communication quality among the plurality of eigenpaths, or a transmission weight which renders difference in communication qualities of the eigenpaths equal to or less than a predetermined value and maximizes a sum of all communication qualities of the plurality of eigenpaths. The transmission control unit 23, when not reducing the size of the packet, controls so as to generate a plurality of packets and to transmit the packets by respective eigenpaths and determines (selects) a transmission weight which maximizes overall communication quality of the plurality of eigenpaths. The transmission weight policy determination unit 24, when transmitting a packet, obtains a type of the packet to be transmitted and determines whether to reduce a size of the packet.

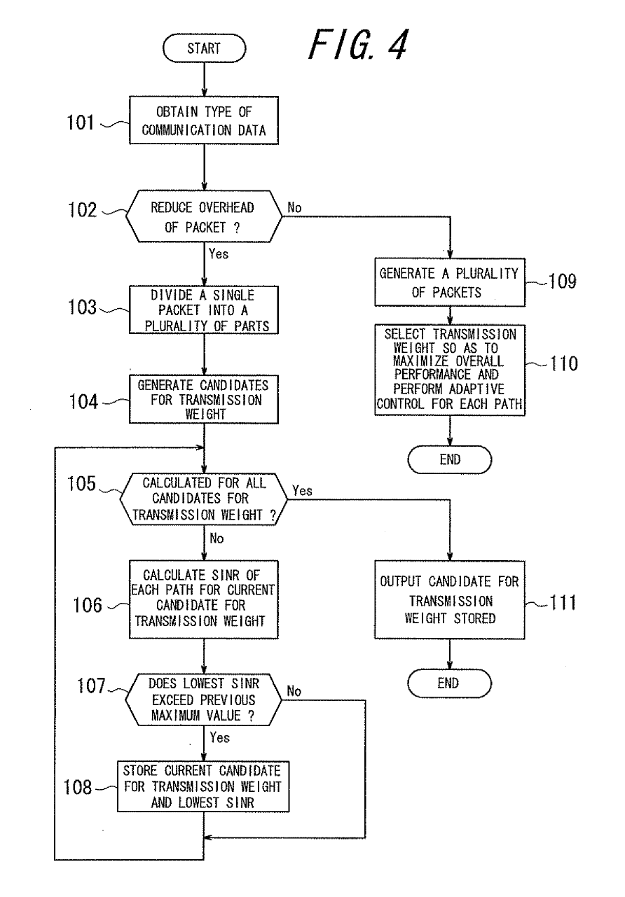

FIG. 4 is a flowchart illustrating a first embodiment to select a transmission weight. In a configuration of the wireless communication system shown in FIG. 1, first, the transmission weight policy determination unit 24 obtains the type of the packet to be transmitted (step 101) and determines whether to reduce overhead of the packet (step 102). If the type of the packet to be transmitted is a voice packet such as VOIP (Voice Over IP) data in which a size of each packet is small, the transmission weight policy determination unit 24 determines to reduce overhead of the packet. When reducing overhead of the packet (if Yes), the transmission control unit 23 controls so as to divide a single packet into a plurality of parts (step 103).

Next, the transmission weight generation unit 21 generates candidates for the transmission weight (step 104). Furthermore, the communication quality obtain unit 22 determines whether calculation of SINR of the eigenpaths for all candidates for the transmission weight is finished (step 105). If calculation is not finished (if No), SINR for each eigenpath for a current candidate for the transmission weight is calculated (step 106). Next, the transmission control unit 23 determines whether SINR of a lowest eigenpath with a smallest eigenvalue exceeds a maximum value of SINR of the lowest eigenpath previously calculated (step 107). If the SINR exceeds the maximum value (if Yes), the current candidate for the transmission weight and SINR of the lowest eigenpath are stored (step 108). If the SINR does not exceed the maximum value (if No), the communication quality obtain unit 22 once again determines whether calculation of SINR of the eigenpaths for all candidates for the transmission weight is finished (step 105). If calculation is finished for all candidates for the transmission weight (if Yes), the transmission control unit 23 outputs the candidate for the transmission weight stored (step 111).

If not reducing overhead of the packet at step 102 (if No), the configuration of the wireless communication system is switched to that of the wireless communication system shown in FIG. 2, and the transmission control unit 23 generates a plurality of packets (step 109), controls so as to transmit the packets by respective eigenpaths, and determines (selects) a transmission weight which maximizes overall communication quality of the plurality of eigenpaths and performs adaptive control on each eigenpath (step 110).

In the above embodiment, the transmission control unit 23 determines (selects) the transmission weight so as to maximize the communication quality of the lowest eigenpath with the smallest eigenvalue among the plurality of eigenpaths. However, when the propagation path varies or an estimation error is recognized, for example, it is possible to determine (select) a transmission weight so as to maximize communication quality of an eigenpath with relatively low communication quality among the plurality of eigenpaths.

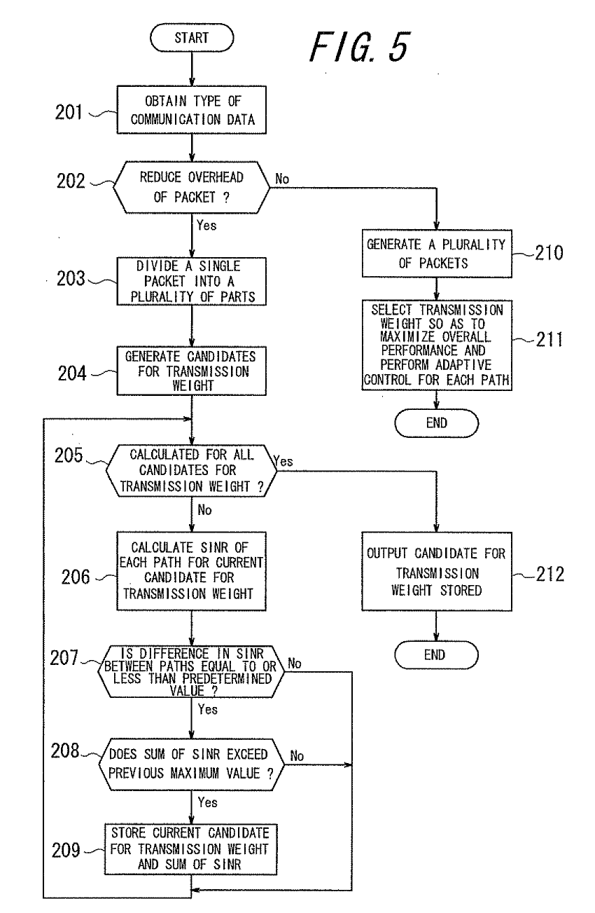

FIG. 5 is a flowchart illustrating a second embodiment to select the transmission weight. In a configuration of the wireless communication system shown in FIG. 1, first, the transmission weight policy determination unit 24 obtains the type of the packet to be transmitted (step 201) and determines whether to reduce overhead of the packet (step 202). If the type of the packet to be transmitted is a voice packet such as VOIP (Voice Over IP) data in which a size of each packet is small, the transmission weight policy determination unit 24 determines to reduce overhead of the packet. When reducing overhead of the packet (if Yes), the transmission control unit 23 controls so as to divide a single packet into a plurality of parts (step 203).

Next, the transmission weight generation unit 21 generates candidates for the transmission weight (step 204). In addition, the communication quality obtain unit 22 determines whether calculation of SINR of the eigenpaths for all candidates for the transmission weight is finished (step 205). If calculation is not finished (if No), SINR of each eigenpath for a current candidate for the transmission weight is calculated (step 206). Next, the transmission control unit 23 determines whether difference in SINR between eigenpaths for the current candidate for the transmission weight is equal to or less than the predetermined value (step 207). Specifically, the transmission control unit 23 determines whether the difference in SINR between eigenpaths satisfies the following formula:

10 log(SINR_{MAX}−SINR_{MIN})≦8[dB] [Formula 1]

When the difference in SINR satisfies this formula 1 (if YES), the transmission control unit 23 determines whether a sum of respective SINR of eigenpaths exceeds the maximum value of a sum of SINR calculated previously (step 208). If exceeding (if Yes), the transmission control unit 23 stores the current candidate for the transmission weight and the sum of SINR (step 209). When the difference in SINR is greater than the predetermined value at step 207 (if No), and when the sum of SINR does not exceed the maximum value (if No), the communication quality obtain unit 22 once again determines whether calculation of SINR of eigenpaths for all candidates for the transmission weight is finished (step 202). If the calculation for all candidates for the transmission weight is finished (if Yes), the transmission control unit outputs the transmission weight stored (step 212).

If not reducing overhead of the packet at step 102 (if No), the configuration of the wireless communication system is switched to that of the wireless communication system shown in FIG. 2, and the transmission control unit 23 generates a plurality of packets (step 210), controls so as to transmit the packets by the respective eigenpaths, and determines (selects) the transmission weight which maximizes overall communication quality of the plurality of eigenpaths and performs adaptive control on each eigenpath (step 211).

Although the transmission weight policy determination unit 24 determines to reduce overhead of the packet if the type of the packet to be transmitted is a voice packet such as VOIP data, in which the size of each packet is small, it is also possible to determined to reduce overhead of the packet when a band to transmit the packet is a narrowband.

In addition, although SINR is used as the communication quality in the above embodiments, when the propagation path varies and an estimation error is recognized, another index such as SNR (Signal to Noise Ratio) or SIR (Signal to Interference Ratio) is used as the communication quality.

Moreover, although it is assumed to use the same modulation scheme for all eigenpaths when controlling to divide the single packet into the plurality of parts in the above embodiment, the present invention is also applicable when the same modulation scheme is used for a plurality of eigenpaths.

1. A wireless communication system for performing wireless communication via a plurality of paths between a transmission apparatus and a reception apparatus, comprising:
a communication quality obtain unit for obtaining information on communication quality of each of the paths; and
a transmission control unit for controlling the transmission apparatus, when the transmission apparatus reduces packet size to transmit a packet, to transmit the packet by dividing it into the plurality of paths and for determining a transmission weight such that respective communication qualities of the paths become equivalent.

2. The wireless communication system according to claim 1, wherein the transmission control unit determines a transmission weight which maximizes communication quality of a path with relatively low communication quality among the plurality of paths.

3. The wireless communication system according to claim 1, further comprising a transmission weight generation unit for generating a plurality of transmission weights,
wherein the transmission control unit selects a transmission weight, among the transmission weights generated by the transmission weight generation unit, such that difference in values indicating communication qualities of the paths obtained by the communication quality obtain unit is equal to or lower than a predetermined value and a sum of all communication qualities of the plurality of paths is maximized.

4. The wireless communication system according to claim 1, wherein the transmission apparatus reduces packet size when a packet to transmit is a voice packet.

5. The wireless communication system according to claim 1, wherein the transmission apparatus reduces packet size when a band to be used to transmit a packet is a narrowband.

6. The wireless communication system according to claim 1, wherein the transmission control unit controls the transmission apparatus, when the transmission apparatus does not reduce the packet size to transmit the packet, to generate a plurality of packets and to transmit the packets by respective paths, and determines a transmission weight which maximizes overall communication quality of the plurality of paths.

7. A transmission apparatus for performing wireless communication via a plurality of paths,
the transmission apparatus transmitting a packet by dividing it into the plurality of paths when reducing packet size to transmit the packet, and applying a transmission weight such that respective communication qualities of the paths become equivalent.

8. A communication control method of a wireless communication system for performing wireless communication via a plurality of paths between a transmission apparatus and a reception apparatus, comprising the steps of:
obtaining information on communication quality of each of the paths; and
controlling the transmission apparatus, when the transmission apparatus reduces packet size to transmit a packet, to transmit the packet by dividing it into the plurality of paths, and determining a transmission weight such that respective communication qualities of the paths become equivalent.
